(19) United States
(12) Patent Application Publication
(10) Pub. No.: US 2002/0095359 A1
(43) Pub. Date: Jul. 18, 2002

(54) Information providing system, connection control server, and connecting and accounting method

(75) Inventor: Kenji Mangetsu, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/021,274

(22) Filed: Dec. 19, 2001

(30) Foreign Application Priority Data
Dec. 20, 2000 (JP) 2000-387846

(51) Int. Cl. G06F 17/60

(52) U.S. Cl. 705/30

(57) ABSTRACT

In an information providing system including an access point, an information providing server, and an accounting server, the access point is supplied from a communication terminal with an information obtaining request and specifying-information specifying desired information and transmits the information obtaining request and the specifying-information to the information providing server. The access point receives and memorizes candidate information transmitted from the information providing server in response to the information providing request and the specifying-information. The access point prepares a list of the received candidate information and sends the list to the communication terminal. The access point receives, from the communication terminal, selection information for selecting particular information in the list and sends, to the communication terminal, the particular information specified by the selection information. The accounting server carries out a charging operation for the particular information transmitted to the communication terminal.

### BACKGROUND OF THE INVENTION

This invention relates to a system and a method for providing information to a user who accesses an access point from his or her communication terminal to use an information contents providing service and for charging the user for the information required by the user.

As an existing accounting system upon using an information contents providing service, use is generally made of a flat-fee charging scheme based on a preselected service time as a specified limit time, a rate-based charging scheme depending upon an actual service time as an actual connect time, or a rate-based charging scheme depending upon a data quantity of the information transmitted and received.

In the flat-fee charging scheme based on the preselected service time, a user must take the specified limit time into consideration when he uses the information contents providing service. Beyond the specified limit time, the user must pay an additional fee calculated at a relatively high rate. Thus, this charging scheme is inconvenient for the user.

In the rate-based charging scheme depending upon the actual service time, the user is charged for the actual connect time even if the user has received undesired or low-value information contents. Similarly, in the rate-based charging scheme depending upon the data quantity, the user is charged even for such undesired or low-value information contents.

Presently, the user can not judge whether the information is useful or not until the user receives and reads the information. As a result, the user often pays a service charge even for valueless information.

Thus, in the above-mentioned accounting system for the information contents providing service, the service charge is often unacceptable to the user.

### SUMMARY OF THE INVENTION

It is therefore an object of this invention to provide a system and a method in which a user is charged for information useful to the user.

It is another object of this invention to provide an information providing system and an information providing service which are convenient for a user.

According to a first aspect of this invention, there is provided an information providing system comprising:

an access point;

an information providing server; and

an accounting server;

the access point comprising:

transmitting means supplied from a communication terminal with an information obtaining request and specifying-information specifying desired information for transmitting the information obtaining request and the specifying-information to the information providing server;

receiving and memorizing means for receiving and memorizing candidate information transmitted from the information providing server in response to the information providing request and the specifying-information;

means for preparing a list of the candidate information received by the receiving and memorizing means and for sending the list to the communication terminal; and

means for receiving, from the communication terminal, selection information for selecting particular information in the list, for extracting the particular information specified by the selection information from the candidate information memorized in the receiving and memorizing means, and for sending the particular information to the communication terminal;

the accounting server comprising means for carrying out a charging operation for the particular information transmitted to the communication terminal.

With the above-mentioned structure, the user transmits the information providing request and the specifying-information specifying the desired information to the access point. In response to the information providing request and the specifying-information, the access point prepares the list of the candidate information transmitted from the information providing server and sends the list to the communication terminal. The user selects the particular information from the list received by the communication terminal and acquires the particular information as the desired information. Thus, the above-mentioned system is convenient for the user. Furthermore, the user is charged for the particular information finally acquired. Therefore, a service charge can be minimized. Again, the above-mentioned system is convenient for the user.

Among a plurality of contents possessed by the information providing server, the user can acquire a desired content in accordance with content specifying-information.

The user may acquire a desired web page from web pages possessed by the information providing server or a linkable related web page in accordance with web page specifying-information.

Furthermore, the user can search a database possessed by the information providing server in accordance with desired data specifying-information to acquire a desired retrieval result.

Alternatively, the user can execute a desired application program among application programs possessed by the information providing server in accordance with application program specifying-information to acquire a desired execution result.

The accounting server may further charge the user also for preparation of the list of the candidate information transmitted from the information providing server and provision of the list to the communication terminal.

The information providing server may preliminarily memorize ID information for identifying each admitted user allowed to obtain desired information from the information providing server. The information providing server judges whether or not ID information coincident with a user ID code transmitted from the communication terminal is preliminarily registered and, if the ID information coincident with the user ID code is registered, the information providing server transmits the desired information to the communication terminal.

The information providing server may be connected through a network to the access point or may be accommodated in the access point.

The accounting server may have a database storing an accounting table including accounting data corresponding to service charges for each user. Based on the desired information supplied from the access point to the communication terminal, the accounting data in the accounting table for the user of the communication terminal is updated.

The accounting server may update the accounting data in the accounting table for the user of the communication terminal on the basis of a data quantity of the desired information provided to the communication terminal or a predetermined unit price of the desired information.

The access point may detect completion of provision of the desired information to the communication terminal and, after completion of provision of the desired information, request the accounting server to carry out the charging operation.

According to a second aspect of this invention, there is provided a connection control server for relaying communication between a communication terminal and an information providing server, the connection control server comprising:

means supplied from the communication terminal with an information obtaining request and specifying-information specifying desired information for transmitting the information obtaining request and the specifying-information to the information providing server;

means for receiving candidate information transmitted from the information providing server in response to the information providing request and the specifying-information;

means for preparing a list of the candidate information to send the list to the communication terminal;

means for receiving, from the communication terminal, selection information for selecting particular information in the list to send the particular information specified by the selection information from the candidate information to the communication terminal; and

means for requesting a charging operation for the particular information transmitted to the communication terminal.

With the above-mentioned structure, the connection control server is supplied with the Information providing request and the specifying-information specifying the desired information which are transmitted from the communication terminal by the user, and transfers the information providing request and the specifying-information to the information providing server. The connection control server prepares the list of the candidate information provided from the information providing server in response to the information providing request and the specifying-information, and transmits the list to the communication terminal. The user selects the particular information from the list received by the communication terminal and acquires the particular information as the desired information. Thus, the above-mentioned connection control server is convenient for the user. Furthermore, the user is charged for the particular information finally acquired. Therefore, a service charge can be minimized. Again, the above-mentioned connection control server is convenient for the user.

According to a third aspect of this invention, there is provided a connecting and accounting method comprising the steps of:

transmitting an information providing request and specifying-information specifying desired information from a communication terminal to an information providing server;

receiving candidate information transmitted from the information providing server in response to the information providing request and the specifying-information;

preparing a list of the candidate information to send the list to the communication terminal,

receiving, from the communication terminal, selection information for selecting particular information in the list to send the particular information specified by the selection information from the candidate information to the communication terminal; and

executing a charging operation for the particular information transmitted to the communication terminal.

According to the above-mentioned method, the user transmits from the communication terminal to the information providing server the information providing request and the specifying-information specifying the desired information. In response to the information providing request and the specifying-information, the list of the candidate information provided by the information providing server is prepared. The list is received by the communication terminal. The user selects the particular information from the list received by the communication terminal and acquires the particular information as the desired information. Thus, the above-mentioned method is convenient for the user. Furthermore, the user is charged for the particular information finally acquired. Therefore, a service charge can be minimized. Again, the above-mentioned method is convenient for the user.

According to a fourth aspect of this invention, there is provided a program for operating a computer as a connection control connection control server for relaying communication between a communication terminal and an information providing server, the connection control server comprising:

means supplied from the communication terminal with an information obtaining request and specifying-information specifying desired information for transmitting the information obtaining request and the specifying-information to the information providing server;

means for receiving candidate information transmitted from the information providing server in response to the information providing request and the specifying-information;

means for preparing a list of the candidate information to send the list to the communication terminal:

means for receiving, from the communication terminal, selection information for selecting particular information in the list to send the particular information specified by the selection information from the candidate information to the communication terminal; and

means for requesting a charging operation for the particular information transmitted to the communication terminal.

With the above-mentioned structure, the connection control system is operated in accordance with the program memorized in a recording medium. Specifically, the connection control system transfers to the information providing server the information providing request and the specifying-information specifying the desired information which are transmitted from the communication terminal by the user. In response to the information providing request and the specifying-information, the list of the candidate information provided from the information providing server is prepared. The list is transmitted to the communication terminal. The user selects the particular information from the list received by the communication terminal and acquires the particular information as the desired information, Thus, the above-mentioned recording medium is convenient for the user. Furthermore, the user is charged for the particular information finally acquired. Therefore, a service charge can be minimized. Again, the above-mentioned recording medium is convenient for the user.

### BRIEF DESCRIPTION OF THE DRAWING

FIG. 1 is a schematic view showing an information providing system according to a first embodiment of this invention;

FIG. 2 shows a communication administrating server in an access point illustrated in FIG. 1;

FIG. 3 shows an example of a communication administrating file;

FIG. 4 shows the structure of an accounting server illustrated in FIG. 1;

FIG. 5 shows an example of an accounting record file;

FIG. 6 is a flow chart for describing an operation of the information providing system illustrated in FIG. 1;

FIG. 7 is a schematic view showing an information providing system according to a second embodiment of this invention; and

FIG. 8 is a flow chart for describing an operation of the information providing system illustrated in FIG. 7.

### DESCRIPTION OF PREFERRED EMBODIMENTS

Now, description will be made of preferred embodiments of this invention with reference to the drawing.

### First Embodiment

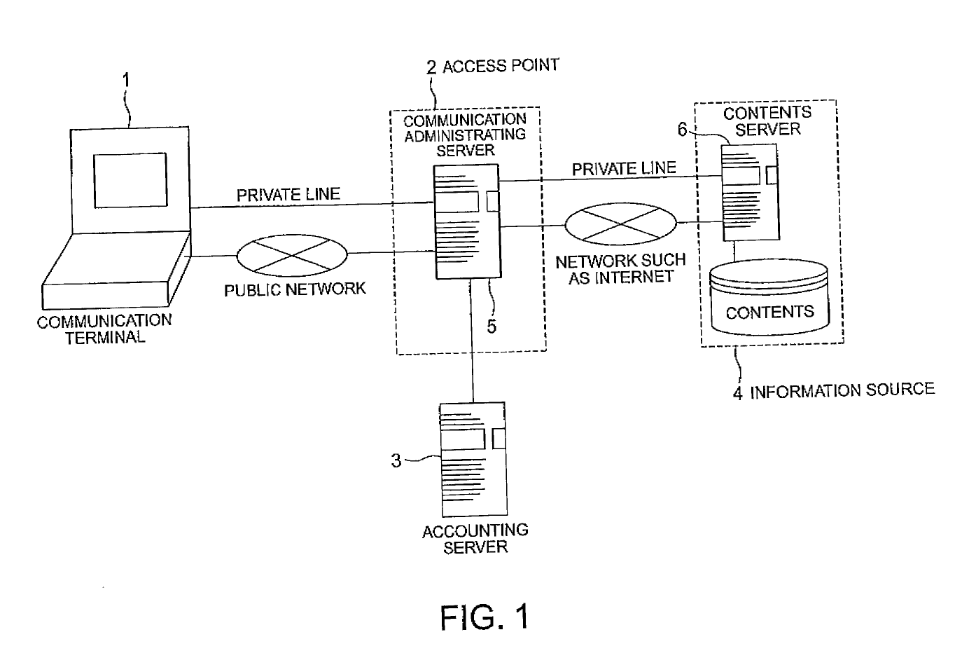

Referring to FIG. 1, an information providing system according to a first embodiment of this invention includes a plurality of communication terminals (only one being illustrated in the figure) used by a plurality of users, an access point 2, an accounting server 3, and an information source 4 including a contents server 6 and a contents database. The information source 4 is also called an information providing server.

The communication terminal 1 comprises a communicable terminal such as a personal computer, a PDA (Personal Data Assistance), a mobile telephone, and a PHS (Personal Handy phone System). The communication terminal 1 can be connected to the access point 2 through a public network or a private line.

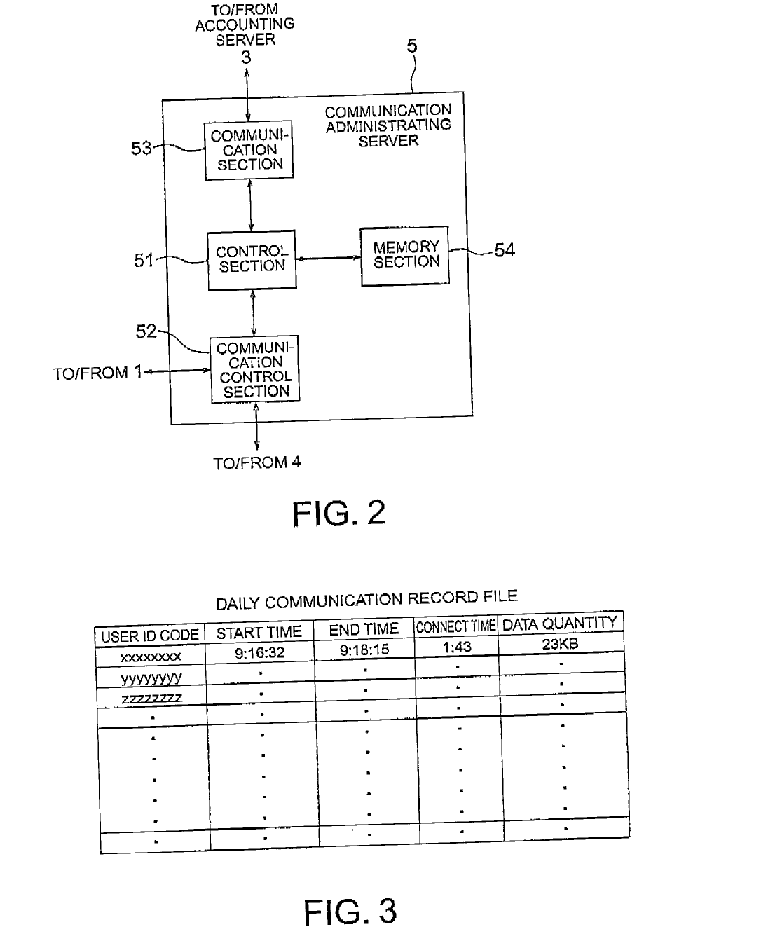

The access point 2 is, for example, operated by a network access provider. The access point 2 has a communication administrating server 5 and controls communication between the communication terminal 1 and the information source 4. As illustrated in FIG. 2, the communication administrating server 5 comprises a control section 51, a communication control section 52, a communicating section 53, and a memory section 54. The control section 51 is responsive to a request from the communication terminal 1 and executes an operation of acquiring information from the information source 4 to provide the information to the communication terminal 1. In addition, the control section 51 cooperates with the accounting server 3 to execute a charging operation for the information provided to the communication terminal 1. The communication control section 52 controls communication among the communication terminal 1, the contents server 6, and the communication administrating server 5. The communicating section 53 carries out communication between the communication administrating server 5 and the accounting server 3. The memory section 54 memorizes a daily communication record or log file as illustrated in FIG. 3. For each communication event, the control section 51 makes the memory section 54 successively memorizes a user ID (identification) code of a user, a communication start time instant, a communication end time instant, a connection time period, a transfer data quantity, and so on.

The accounting server 3 is responsive to a request from the access point 2 and carries out the charging operation for the information requested by the user.

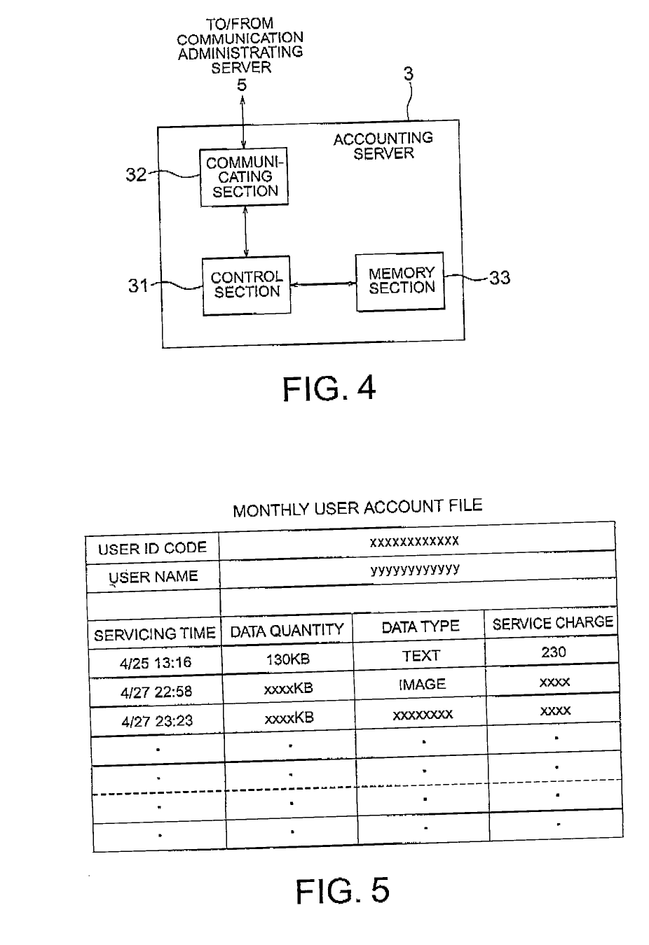

As illustrated in FIG. 4, the accounting server 3 comprises a control section 31, a communicating section 32, and a memory section 33. The control section 31 performs various procedures for the charging operation. The communicating section 32 carries out communication between the accounting server 3 and the communication administrating server 5. The memory section 33 memorizes, as a monthly user account file, an accounting record file on a monthly basis for each user, as illustrated in FIG. 5. Under control of the control section 31, the monthly user account file successively records a date and a time of a servicing session, a data quantity and a data type of the information requested by the user, and a service charge. With reference to the monthly user account file, the control section 31 calculates a monthly total charge for each user and executes a billing operation.

The contents server 6 is connected to the access point 2 through an Internet, a private line, or the like. The information source 4 provides, as user services, information contents such as various kinds of electronic dictionaries, various kinds of databases, various kinds of application programs, and WWW (World Wide Web) web pages. In this embodiment, the information source 4 comprises a database as the contents server 6.

### Operation

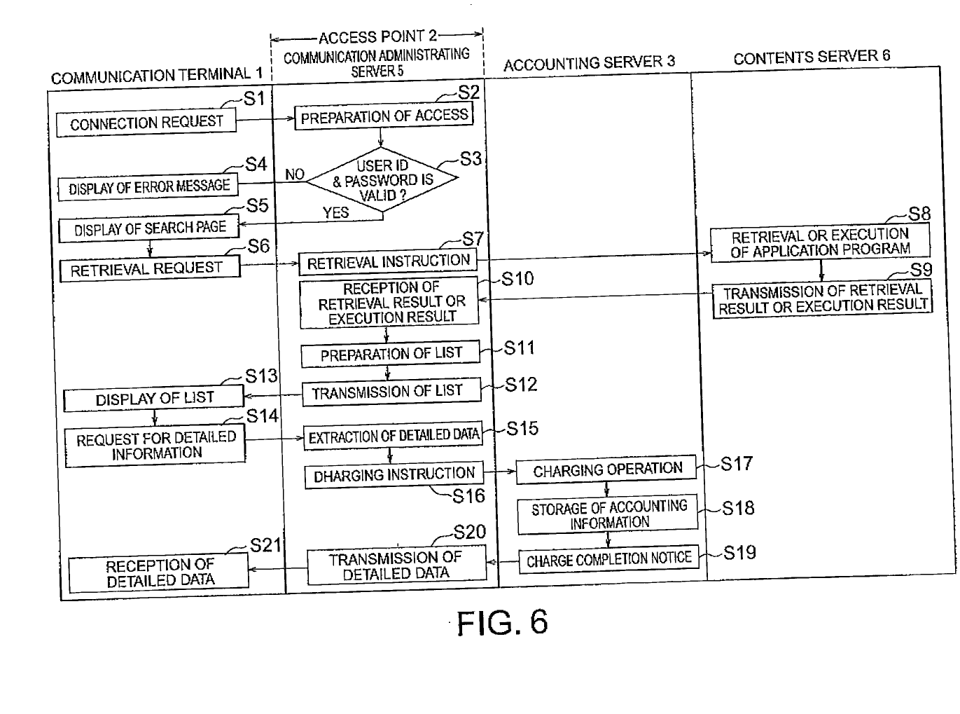

Referring to FIG. 6, description will be made of an operation of the information providing system of the above-mentioned structure, particularly, in conjunction with acquisition of the information contents by the communication terminal 1 and the charging operation for the information contents thus acquired.

The user sends a connection request from the communication terminal 1 to the communication administrating server 5 in the access point 2, specifying a user ID code and a password assigned to the user (step S1). The control section 51 of the communication administrating server 5 receives the connection request through the communication control section 52 (step S2) and checks the user ID code and the password (step S3). If the result of checking shows incoincidence (NO in step S3), an error message is displayed on the communication terminal 1 (step S4).

On the other hand, if the result of checking shows coincidence (YES in step S3), the communication administrating server 5 establishes a session with the communication terminal 1 (step S5).

The communication terminal 1 of the user displays a search page for information retrieval on a display screen (step S5). The search page may be transmitted from the communication administrating server 5 or may be preliminarily memorized in the communication terminal 1.

On the search page displayed on the communication terminal 1, the user inputs specifying-information specifying desired information to be retrieved and an information retrieval request (that is, an information obtaining request) for the desired information (step 56).

The communication terminal 1 is responsive to the information retrieval request of the user and transmits the information retrieval request and the specifying-information specifying the desired information to the communication administrating server 5.

The communication administrating server 5 is responsive to the information retrieval request and the specifying-information and transfers, to the contents server 6, the information retrieval request and the specifying-information as a retrieval instruction (step S7). Supplied with the retrieval instruction, the contents server 6 searches and retrieves candidate information presumably matching the desired information (step S8).

The contents server 6 transmits the candidate information to the communication administrating server 5 (step S9).

The communication administrating server 5 receives the candidate information from the contents server 6 and makes the memory section 54 memorize the candidate information (step S10). Next, the communication administrating server 5 prepares a list of summaries of the candidate information (step S11) and transmits the list to the communication terminal 1 of the user (step S12).

The communication terminal 1 displays the list on the display screen (step S13). The user checks the list displayed on the display screen and selects, as selected information, a particular one (or ones) of the candidate information for which the user desires to acquire detailed information. The communication terminal 1 is responsive to the selecting operation of the user and transmits to the communication administrating server 5 an information ID code specifying the selected information (step S14).

The communication administrating server 5 receives the information ID code and accesses the memory section 54 to read as the selected information a corresponding one of the candidate information which corresponds to the information ID code (step S15). The communication administrating server 5 transmits to the accounting server 3 the user ID code, the data quantity and the data type of the selected information, and a charging instruction (step S16).

The accounting server 3 is responsive to the charging instruction and calculates a service charge with reference to the data quantity and the data type informed as described above (step S17) and writes the date and the time, the data quantity, the data type, and the service charge into the monthly user account file (FIG. 5) specified by the user ID code (step S18).

When the above-mentioned charging operation is completed, the accounting server 3 transmits a charge completion notice to the communication administrating server 5 (step S19).

The communication administrating server 5 is responsive to the charge completion notice and transmits the selected information selected by the user to the communication terminal 1 (step 320).

The communication terminal 1 receives and displays the selected information from the communication administrating server 5 (step S21).

Subsequently, the steps S5 to S21 are repeated until the session is disconnected.

For example, at a settling day such as a month end, the accounting server 3 calculates a total amount of the service charges in the monthly user account file for each user to issue a bill.

In the above-mentioned system, the user at first receives the list of the summaries of a large quantity of the candidate information retrieved by the contents server 6 and then receives the detail of the selected information selected from the list by the user himself. Therefore, it is possible to prevent reception of a large quantity of valueless information, which may possibly be contained in the candidate information, and time-consuming selection from the candidate information.

It is also possible to reduce a communication time of communication between the communication terminal 1 and the communication administrating server 5 and the number of communication packets transmitted to the communication terminal 1 Therefore, the volume of communication is also suppressed and occurrence of an unnecessary cost is avoided.

Furthermore, the user is not charged for a large quantity of the candidate information retrieved by the contents server 6 but is charged for the selected information selected by the user himself. Therefore, the user is satisfied with the service charge in most cases.

### Modifications

In the foregoing embodiment, the information source 4 comprises the database. The information provided by the information source 4 is the information retrieved from the database. However, the information source 4 may have any desired structure and may provide any desired type of information.

Hereinafter, description will successively made of cases where the information source 4 provides an electronic dictionary, an application program, and a WWW web page.

### First Modification

At first, description will be made of the case where the information source 4 provides the electronic dictionary.

In this case, the contents server 6 comprises a dictionary server. The contents database stores dictionary data. The dictionary server may include not only an ordinary dictionary such as an English language dictionary, an English-Spanish dictionary, and a Spanish-English dictionary but also a less available dictionary of an uncommon language such as Arabic, Swahili, and Hindi as well as a dictionary of conjugation.

The user sends a connection request from the communication terminal 1 to the communication administrating server 5. The communication administrating server 5 carries out a predetermined authentication process and, if the authentication process is successful, establishes connection (steps S1 through S4).

On a search page displayed on the communication terminal 1, the user inputs a retrieval request and specifying-information specifying, for example, a desired type of dictionary and a target word as a retrieval object (steps S5 and S6).

Supplied from the communication terminal 1 with the retrieval request and the specifying-information specifying the retrieval object, the communication administrating server 5 transmits the retrieval request and the specifying-information to the dictionary server (step S7).

The dictionary server searches and retrieves the target word from the desired type of dictionary specified by the specifying-information and sends a retrieval result to the communication administrating server 5 (steps S8 and S9).

The communication administrating server 5 at first holds the retrieval result transferred from the dictionary server (step S10). If a plurality of parts of speech are present for the target word or if the retrieval of usages and idioms for the target word is desired, a list of the parts of speech and a list of summaries of the usages and the idioms are produced, respectively, and transmitted to the communication terminal 1 (steps S11 and S12).

The communication terminal 1 receives and displays the list (step S13). The user selects desired information from the list and transmits a transfer request for the desired information from the communication terminal 1 to the communication administrating server 5 (step S14).

The communication administrating server 5 extracts the desired information (step S15) and requests the accounting server 3 to perform a charging operation, informing the user ID code of the user as a destination, the data quantity and the data type of the desired information, and so on (step S16). In response to the request, the accounting server 3 writes charging information into the monthly user account file illustrated in FIG. 5 (steps S17 to S19).

Thereafter, the communication administrating server 5 transmits a whole content of the desired information to the communication terminal 1 (steps S20 and 521).

### Second Modification

Next, as a technique of remotely using computer resources, description will be made of the case where a desired application program on the contents server 6 is used by the communication terminal 1.

In this case, the contents server 6 comprises an application server for executing various computer programs stored in the contents database and transmitting an execution result to the communication terminal 1.

The user sends a connection request from the communication terminal 1 to the communication administrating server 5. The communication administrating server 5 carries out a predetermined authentication process and, if the authentication process is successful, establishes connection (steps S1 through S4).

On a search page displayed on the communication terminal 1, the user inputs specifying-information specifying a desired type of application program and a target information content to be acquired, together with an execution request for execution of the application program (steps S5 and S6).

By way of example, it is assumed here that an application program for obtaining travel information such as a route between two stations as designated start and end points, the fare, the required time, and transportation means.

Supplied from the communication terminal 1 with the execution request and the specifying-information, the communication administrating server 5 transmits the execution request and the specifying-information to the application server (step S7).

The application server executes the desired application specified by the specifying-information to obtain the route, the fare, the required time, the transportation means, and the like and transmits the result of execution to the communication administrating server 5 (steps S8 and S9).

The communication administrating server 5 receives the result of execution transferred from the contents server 6 and at first holds the result of execution (step S10). For example, the communication administrating server 5 prepares, as a summary, outlines of candidate routes and partial information about the transportation means (step S11). The communication administrating server 5 transmits the above-mentioned summary to the communication terminal 1 (step S12).

The communication terminal 1 displays the summary supplied thereto (step S13). The user selects desired information and transmits a transfer request for the desired information to the communication administrating server 5 (step S14).

The communication administrating server 5 extracts the desired information (step S15) and requests the accounting server 3 to perform a charging operation, informing the user ID code of the user as a destination, the data quantity and the data type of the desired information, and so on (step S16). in response to the request, the accounting server 3 writes charging information into the monthly user account file illustrated in FIG. 5 (steps S17 through S19).

Thereafter, the communication administrating server 5 transmits a whole content of the desired information to the communication terminal 1 (steps S20 and S21).

The above-mentioned structure is also applicable to a system in which the communication terminal 1 and the contents server 6 in the information source 4 are operated on different OS's (Operating Systems).

### Second Embodiment

In the information providing system according to the first embodiment, the communication terminal 1 and the contents server 6 must be communicable with each other. Hereinafter, description will be made of a system in which the communication terminal 1 can access any desired information even if the communication terminal 1 and the contents server 6 are not communicable with each other because of the difference in OS.

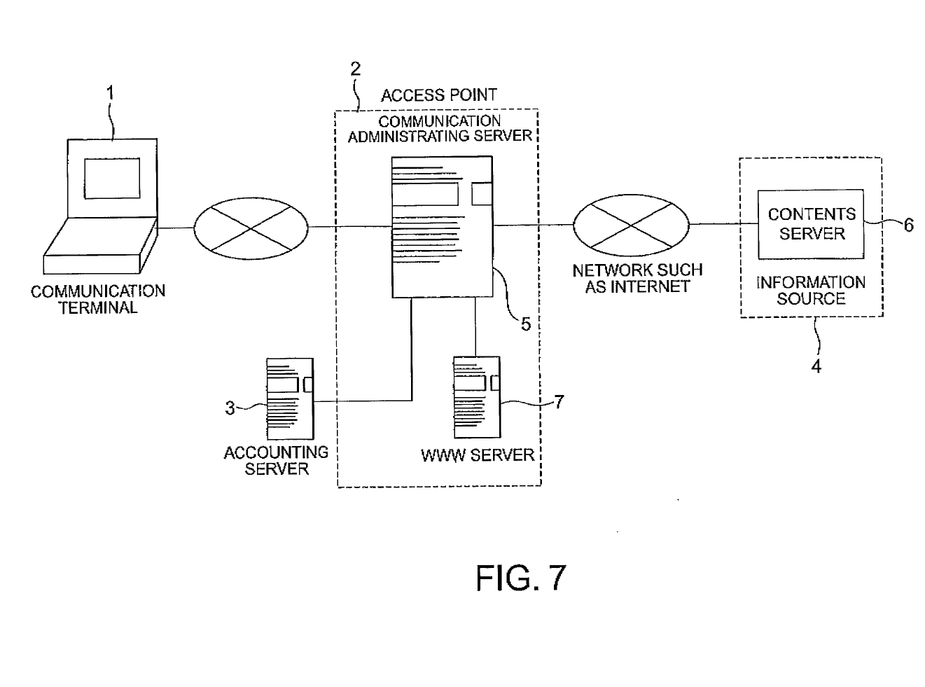

In the first embodiment and the first and the second modifications, the access point 2 comprises the communication administrating server 5. On the other hand, in the second embodiment, the access point 2 further includes a WWW server 7 connected to the communication administrating server 5, as illustrated in FIG. 7.

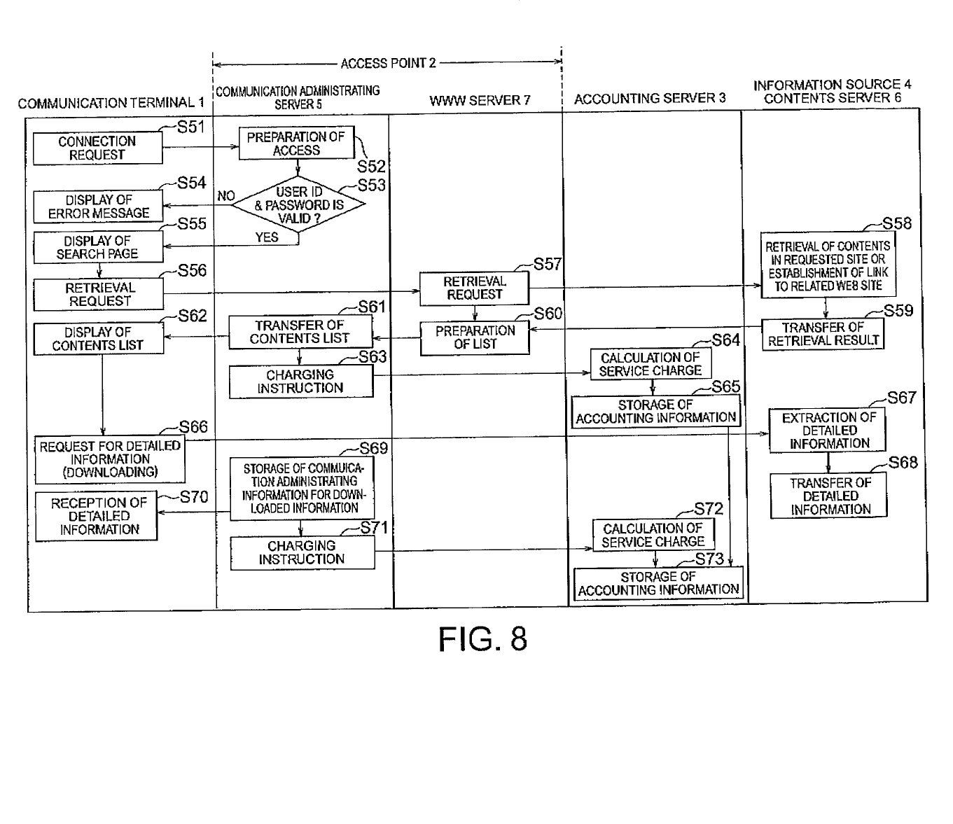

Next referring to FIG. 8, an operation of the second embodiment will be described. The user sends a connection request from the communication terminal 1 through a public network or a private network to the access point 2 as a relay point of communication (step S51). The communication administrating server 5 of the access point 2 receives the connection request (step S52) and checks the user ID code and the password transmitted from the user (step S53). If the result of checking shows incoincidence (NO in step 553), an error message is displayed on the communication terminal 1 (step S54).

On the other hand, if the result of checking shows coincidence (YES in step S53), the communication administrating server 5 establishes a session with the communication terminal 1. The communication terminal 1 displays a search page for information retrieval (step S55).

On the search page displayed on the communication terminal 1, the user inputs an information retrieval request (that is, an information obtaining request) for requesting the access point 2 to retrieve desired information (step S56). That is, the user inputs specifying-information specifying the desired information to be retrieved and the information retrieval request for the desired information.

The communication administrating server 5 transfers the information retrieval request and the specifying-information from the communication terminal to the WWW server 7 in the access point 2. In response to the information retrieval request and the specifying-information, the WWW server 7 searches the desired information in a web site of a provider who operates the access point 2 or in a linkable related web site accessible from the WWW server 7 (step S57).

Furthermore, the WWW server 7 requests the contents server 6 (which serves as an external WWW server) in the information source 4 connected through the Internet to conduct the retrieval requested by the user in its web site or a related web site (step S58). In this event, the WWW server 7 requests the contents server (the external WWW server) 6 by transmitting the information retrieval request and the specifying-information to the contents server (the external WWW server) 6.

In response to the information retrieval request and the specifying-information, the contents server (the external WWW server) 6 transfers its retrieval result to the WWW server 7 in the access point 2 (step S59).

The WWW server 7 in the access point 2 prepares an HTML document as a contents list on the basis of the retrieval result in its own information contents, the retrieval result in the linkable related web site accessible from the WWW server 7, and the retrieval result received from the contents server (the external WWW server) 6 in the information source 4 (step S60). Next, the communication administrating server 5 transfers the contents list to the communication terminal 1 of the user (step S61). At this time, in the first embodiment, the retrieval result is at first stored in the memory section 54 of the communication administrating server 5. In this second embodiment, the storage of the retrieval result is not essential.

In order to charge the user also for preparation and provision of the contents list also, the communication administrating server 5 calculates the data quantity of the contents list and transmits a charging instruction to the accounting server 3 (step S63).

The communication terminal 1 of the user receives and displays the contents list (step S62).

On the other hand, the accounting server 3 calculates a service charge for preparation and provision of the contents list on the basis of the data quantity informed from the communication administrating server 5 (step S64).

The memory section 33 of the accounting server 3 stores the amount of the service charge until the charging operation is completed (step S65).

The user reviews the contents list displayed on the communication terminal 1 and, if necessary, requests the external WWW server 6 in the information source 4 to download a detailed information content as desired information (step S66).

In response, the information source 4 establishes a link to the desired information or carries out a data extracting operation (step S67) and transfers the desired information to the communication terminal 1 of the user (step S68).

The communication administrating server S in the access point 2 executes a communication administrating operation for the desired information downloaded from the information source 4 to the communication terminal 1 of the user. The communication administrating server 5 produces a communication administrating file including the user ID code, communication start and end time instants, a communication time period, a downloaded data quantity, and so on, as illustrated in FIG. 3 and makes the memory section 54 memorize the communication administrating file (step S69).

The communication administrating server 5 requests the accounting server 3 to perform a charging operation, informing the data type and the data quantity of the desired information downloaded as described above (step 371).

The control section 31 of the accounting server 3 is responsive to the request and calculates a service charge with reference to the data type and the data quantity (step S72). The service charge calculated herein is added to the above-mentioned service charge for preparation and provision of the contents list (steps S64 and S65) to obtain a total service charge. The total service charge is written in the monthly user account file illustrated in FIG. 5 and stored in the memory section 34 (step S73).

On the other hand, the communication terminal 1 of the user receives and displays the detailed information content as the desired information supplied from the information source 4 through the access point 2 (step S70).

As described above, a single-cycle operation of acquiring the contents is completed.

Subsequently, the similar operation including a retrieval request, a searching and retrieving operation, provision of a list and a charging operation therefor, a request for detailed information, and provision of the detailed information and a charging operation therefor is repeated until the session between the communication terminal 1 and the access point 2 is disconnected. The accounting server 3 calculates a monthly charge for each user at an appropriate timing, for example, at a settling day such as a month end and issues a bill.

This invention is not restricted to the embodiments described above but may be modified in various other manners. For example, a combination of the first and the second embodiments can be used.

The access point 2 may comprise a communication relay station including an automatic exchange of a communications carrier or a communication center for carrying out an overall communication administrating operation over a communication area.

In the embodiments described above, the charging operation is based on the data type and the data quantity. Alternatively, it is possible to define a fixed service charge for a single downloading operation and to charge the user depending upon the number of times of the downloading operation.

As described above, according to this invention, it is possible to charge the user for the detailed information selected by the user.

What is claimed is:

1. An information providing system comprising:
an access point;
an information providing server; and
an accounting server;
said access point comprising:
transmitting means supplied from a communication terminal with an information obtaining request and specifying-information specifying desired information for transmitting said information obtaining request and said specifying-information to said information providing server;
receiving and memorizing means for receiving and memorizing candidate information transmitted from said information providing server in response to said information providing request and said specifying-information;
means for preparing a list of said candidate information received by said receiving and memorizing means and for sending said list to said communication terminal; and
means for receiving, from said communication terminal, selection information for selecting particular information in said list, for extracting said particular information specified by said selection information from said candidate information memorized in said receiving and memorizing means, and for sending said particular information to said communication terminal;
said accounting server comprising means for carrying out a charging operation for said particular information transmitted to said communication terminal.

2. An information providing system as claimed in claim 1, wherein said information providing server memorizes a plurality of contents;
said communication terminal supplying said access point with said information obtaining request and the specifying-information specifying a desired content as said desired information;
said access point receiving said information obtaining request and said specifying-information and transmitting said information obtaining request and said specifying-information to said information providing server;
said information providing server being responsive to said information obtaining request and said specifying-information and extracting candidate contents from said plurality of contents memorized therein to transmit said candidate contents to said access point as said candidate information;
said access point receiving and memorizing said candidate contents transmitted from said information providing server, preparing the list of said candidate contents, transmitting said list to said communication terminal, receiving, from said communication terminal, the selection information for selecting a particular content in said list as said particular information, extracting said particular content in accordance with said selection information, and providing said particular content to said communication terminal.

3. An information providing system as claimed in claim 2, wherein said accounting server carries out a charging operation also for preparation of said list and transmission of said list to said communication terminal.

4. An information providing system as claimed in claim 1, wherein said information providing server comprises a WWW (World Wide Web) server;
said communication terminal supplying said access point with said information obtaining request and the specifying-information specifying a desired web page as said desired information;
said access point receiving said information obtaining request and said specifying-information and transmitting said information obtaining request and said specifying-information to said information providing server;
said information providing server being responsive to said information obtaining request and said specifying-information and extracting candidate web pages to transmit said candidate web pages to said access point as said candidate information;
said access point receiving and memorizing said candidate web pages from said information providing server, preparing the list of said candidate web pages, transmitting said list to said communication terminal, receiving, from said communication terminal, the selection information for selecting a particular web page in said list as said particular information, extracting said particular web page in accordance with said selection information, and providing said particular web page to said communication terminal.

5. An information providing system as claimed in claim 4, wherein said accounting server carries out a charging operation also for preparation of said list and transmission of said list to said communication terminal.

6. An information providing system as claimed in claim 1, wherein said information providing server comprises a database;
said communication terminal supplying said access point with said information obtaining request and the specifying-information specifying desired data as said desired information;
said access point receiving said information obtaining request and said specifying-information and transmitting said information obtaining request and said specifying-information to said information providing server;
said information providing server being responsive to said information obtaining request and said specifying-information and extracting candidate data from said database to transmit said candidate data to said access point as said candidate information;
said access point receiving and memorizing said candidate data transmitted from said information providing server, preparing the list of said candidate data, transmitting said list to said communication terminals receiving, from said communication terminal, the selection information for selecting particular data in said list as said particular information, extracting said particular data in accordance with said selection information, and providing said particular data to said communication terminal.

7. An information providing system as claimed in claim 6, wherein said accounting server carries out a charging operation also for preparation of said list and transmission of said list to said communication terminal.

8. An information providing system as claimed in claim 1, wherein said information providing server memorizes a plurality of application programs;
said communication terminal supplying said access point with said information obtaining request and the specifying-information specifying a desired application program as said desired information;
said access point receiving said information obtaining request and said specifying-information and transmitting said information obtaining request and said specifying-information to said information providing server;
said information providing server being responsive to said information obtaining request and said specifying-information and carrying out an execution of executing said desired application program among said plurality of application programs memorized therein to transmit result information representative of results of said execution to said access point as said candidate information;
said access point receiving and memorizing said candidate contents transmitted from said information providing server, preparing the list of said candidate contents, transmitting said list to said communication terminal, receiving, from said communication terminal, the selection information for selecting a particular content in said list as said particular information, extracting said particular content in accordance with said selection information, and providing said particular content to said communication terminal.

9. An information providing system as claimed in claim 8, wherein said accounting server carries out a charging operation also for preparation of said list and transmission of said list to said communication terminal.

10. An information providing system as claimed in claim 1, wherein said information providing server preliminarily memorizes ID (identification) information for identifying each admitted user allowed to obtain desired information from said information providing server;
said communication terminal transmitting a user ID code to said access point;
said access point receiving the user ID code and transmitting the user ID code to said information providing server;
said information providing server judging whether or not ID information coincident with the user ID code transmitted thereto is preliminarily registered and, if registered, transmitting the desired information to said communication terminal.

11. An information providing system as claimed in claim 1, wherein said information providing server is connected through a network to said access point.

12. An information providing system as claimed in claim 1, wherein said information providing server is accommodated in said access point.

13. An information providing system as claimed in claim 1, wherein said accounting server comprises a database storing an accounting table including accounting data corresponding to service charges for each user, said accounting server updating, based on said particular information supplied from said access point to said communication terminal, the accounting data in said accounting table for a user of said communication terminal.

14. An information providing system as claimed in claim 13, wherein said accounting server updates the accounting data in said accounting table for said user of the communication terminal on the basis of a data quantity of said particular information transmitted to said communication terminal.

15. An information providing system as claimed in claim 13, wherein said accounting server updates the accounting data in said accounting table for said user of the communication terminal on the basis of a predetermined unit price of said particular information transmitted to said communication terminal.

16. An information providing system as claimed in claim 1, wherein said access point further comprises means for detecting completion of transmission of said particular information to said communication terminal and means for requesting, after completion of transmission of said particular information, said accounting server to carry out the charging operation for said particular information transmitted to said communication terminal.

17. A connection control server for relaying communication between a communication terminal and an information providing server, said connection control server comprising:
means supplied from said communication terminal with an information obtaining request and specifying-information specifying desired information for transmitting said information obtaining request and said specifying-information to said information providing server;
means for receiving candidate information transmitted from said information providing server in response to said information providing request and said specifying-information;
means for preparing a list of said candidate information to send said list to said communication terminal;
means for receiving, from said communication terminal, selection information for selecting particular information in said list to send said particular information specified by said selection information from said candidate information to said communication terminal; and
means for requesting a charging operation for said particular information transmitted to said communication terminal.

18. A connecting and accounting method comprising the steps of:
transmitting an information providing request and specifying-information specifying desired information from a communication terminal to an information providing server;
receiving candidate information transmitted from said information providing server in response to said information providing request and said specifying-information;
preparing a list of said candidate information to send said list to said communication terminal;
receiving, from said communication terminal, selection information for selecting particular information in said list to send said particular information specified by said selection information from said candidate information to said communication terminal; and
executing a charging operation for said particular information transmitted to said communication terminal.

19. A program for operating a computer as a connection control connection control server for relaying communication between a communication terminal and an information providing server, said connection control server comprising:
means supplied from said communication terminal with an information obtaining request and specifying-information specifying desired information for transmitting said information obtaining request and said specifying-information to said information providing server;
means for receiving candidate information transmitted from said information providing server in response to said information providing request and said specifying-information;
means for preparing a list of said candidate information to send said list to said communication terminal;
means for receiving, from said communication terminal, selection information for selecting particular information in said list to send said particular information specified by said selection information from said candidate information to said communication terminal; and
means for requesting a charging operation for said particular information transmitted to said communication terminal.
